(19) United States
(12) Patent Application Publication
(10) Pub. No.: US 2006/0126873 A1
(43) Pub. Date: Jun. 15, 2006

(54) Apparatus for generating magnetic field in portable wireless terminal for the hearing impaired

(75) Inventor: Chang-Ki Lee, Seoul (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/264,182

(22) Filed: Nov. 1, 2005

(30) Foreign Application Priority Data
Dec. 14, 2004 (KR) 2004-0105533

(51) Int. Cl. H04R 25/00

(52) U.S. Cl. 381/312

(57) ABSTRACT

Disclosed is an apparatus for generating a magnetic field in a portable wireless terminal for a hearing impaired person. In the apparatus, an amplifier amplifies a voice-band electric signal received from a CODEC to a predetermined level, and a coil converts the amplified electric signal into a corresponding magnetic signal. The coil is configured to generate the magnetic signal sufficiently enough to allow a hearing impaired user wearing a hearing aid to make and receive calls with the portable wireless terminal.

### PRIORITY

This application claims priority under 35 U.S.C. § 119 to an application entitled “Apparatus for Generating Magnetic Field for the Hearing Impaired in Portable Wireless Terminal” filed in the Korean Intellectual Property Office on Dec. 14, 2004 and assigned Serial No. 2004-105533, the contents of which are incorporated herein by reference.

### BACKGROUND OF THE INVENTION

1. Field of the Invention

The present invention relates to a portable wireless terminal for the hearing impaired, and more particularly, to a portable wireless terminal with a telecoil (T-coil).

2. Background of the Prior Art

Commonly, portable wireless terminals are compact, light-weight terminals which include multi-functional features to satisfy the demands of users.

Portable wireless terminals (e.g., cellular phones, mobile units, PDA's wireless phones, etc.) typically include various software which is used to for implementing various functions including a basic call function. For example, portable wireless terminals can be provided with a media player for downloading and playing music files and Video On Demand (VOD) files and a photo album for storing captured pictures.

Further, the portable wireless terminals can be provided with various advanced accessories, such as an attachable or built-in digital camera module, a TV broadcasting receiver module and an MP3 (MPEG audio layer 3) player module.

Typically, hearing aids use a telecoil to amplify voice signals received from a telephone's speaker by coupling to a magnetic field produced by the speaker (the magnetically coupled signal) during use, and reproduce the sound produced by the speaker using the magnetically coupled signal which is converted by the hearing aid into an audible tone. The hearing aid reproduces the voice signals at a desired amplitude.

Wireless phones (i.e., cellular phones, digital wireless phones, wireless terminals, etc.) communicate with base-stations using radio-frequency (RF) transmissions. The RF transmission creates an electromagnetic (EM) field around the wireless phone which is known to interfere with telecoils that are used by hearing aids and cause a hum to be emitted by the hearing aid's speaker. Moreover, the internal circuitry of cellular/wireless telephones can create baseband magnetic interference which can also interfere with the telecoils of hearing aids. Although wireless phones were previously exempt from being compatible with hearing aids, the Federal Communications Commission (FCC) has modified the previous exemption for wireless phones under the Hearing Aid Compatibility (HAC) Act of 1988 to require that wireless phone manufacturers and wireless phone service providers make digital wireless phones accessible to individuals who use hearing aids. In this regard, the FCC has set forth regulations which require that one-half of all digital wireless phone models must be compliant with the reduced RF emissions requirements. Moreover, FCC regulations require that digital wireless phone manufacturers make available to carriers within three years at least two HAC-compliant handset models with telecoil coupling for each air interface it produces; and each carrier providing digital wireless services to make available to consumers within three years at least two HAC-compliant handset models with telecoil coupling for each air interface it offers. Wireless phones which meet this new requirement are known as HAC-compliant terminals.

Telecoils used in typical land-line telephone headsets produce a magnetic field in the direction of an induction coil of a hearing aid worn by the telephone's user. The telecoil produces the magnetic field in order to prevent feedback (e.g., whistle, hum, etc.) from being generated when an object such as a telephone handset is placed in close proximity to the hearing aid's microphone. The hearing aid's telecoil couples to the magnetic field and uses this magnetic field to provide a desired tone quality. Although the term “telecoil” typically refers to a coil installed in a hearing aid to receive a magnetic field. the term “telecoil” as used herein refers to a coil installed in a portable wireless terminal to generate a magnetic field, unless context indicates otherwise.

FIGS. 1A and 1B are block diagrams illustrating conventional land-line telephones for the hearing impaired, in which a magnetic field generating structure is shown.

Referring to FIGS. 1A and 1B, a conventional land-line telephone is provided with a device which generates a magnetic field toward a hearing aid (not shown) worn by the telephone's user. For example, a dynamic receiver 10 with an impedance of 150 ohms shown in FIG. 1A, or a Piezo transducer 20 with a T-coil 21 having an impedance of several hundred to several thousand ohms shown in FIG. 1B is used in the conventional land-line telephone to produce a magnetic field in the direction of a user's the hearing aid.

Usually, such a magnetic device is at least 20 mm in diameter and although it may be easily installed in a handset of the land-line telephone, it is not suitable for portable wireless terminals due to the device's relatively large size.

### SUMMARY OF THE INVENTION

It is therefore an object of the present invention to provide a portable wireless terminal including a telecoil for use by the hearing impaired.

It is also an object of the present invention to provide a portable wireless terminal including a coil capable of producing a magnetic field of sufficient strength in the direction of a user's hearing aid.

Further, it is an object of the present invention to provide an apparatus for producing a magnetic field in a portable wireless terminal, in which a voice-band electric signal to be input to a speaker of the portable wireless terminal is converted into a magnetic signal.

Further, the present invention provides a portable wireless terminal which is suitable for use by the hearing impaired.

According to an aspect of the present invention, there is provided an apparatus for producing a magnetic field in a portable wireless terminal for use by a hearing impaired user, the apparatus including a speaker for converting a voice-band electric signal into an audible signal, an amplifier for amplifying the voice-band electric signal to a predetermined level and a telecoil for converting the amplified electric signal into a magnetic signal.

According to another aspect of the present invention, there is provided an apparatus for generating magnetic field in a portable wireless terminal for use by a hearing impaired user, the apparatus including an amplifier for amplifying a voice-band electric signal to a predetermined level, a telecoil for converting the amplified electric signal into a magnetic signal, an attenuator for attenuating the amplified electric signal to a predetermined level and a speaker for converting the attenuated electric signal into an audible signal.

### BRIEF DESCRIPTION OF THE DRAWINGS

The above and other objects, features and advantages of the present invention will become more apparent from the following detailed description when taken in conjunction with the accompanying drawings in which:

FIGS. 1A and 1B are schematic diagrams illustrating conventional land line telephones for the hearing impaired, in which a magnetic field generating structure is shown.

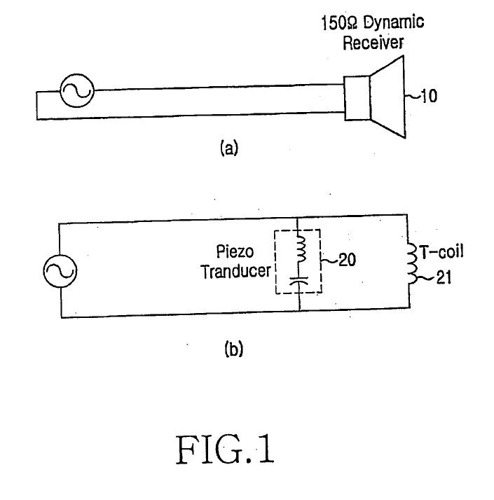

FIG. 2 is a block diagram illustrating a portable wireless terminal for the hearing impaired according to an embodiment of the present invention;

FIG. 3 is a detailed block diagram illustrating a Hearing Aid Compatibility (HAC) portable wireless terminal depicted in FIG. 2;

FIG. 4 is a block diagram illustrating an apparatus for producing a magnetic field in a portable wireless terminal toward a user's hearing aid according to an embodiment of the present invention;

FIG. 5 is a block diagram illustrating an apparatus for producing a magnetic field in a portable wireless terminal toward a hearing aid according to another embodiment of the present invention; and

FIG. 6 is a perspective view showing a portable wireless terminal in an opened position according to an embodiment of the present invention.

### DETAILED DESCRIPTION OF THE PREFERRED EMBODIMENTS

A preferred embodiment of the present invention will now be described in detail with reference to the annexed drawings. In the following description, a detailed description of known functions and configurations has been omitted for conciseness.

A portable wireless terminal, which is provided with a coil capable of producing a magnetic field of sufficient strength in the direction of a hearing aid, will now be described.

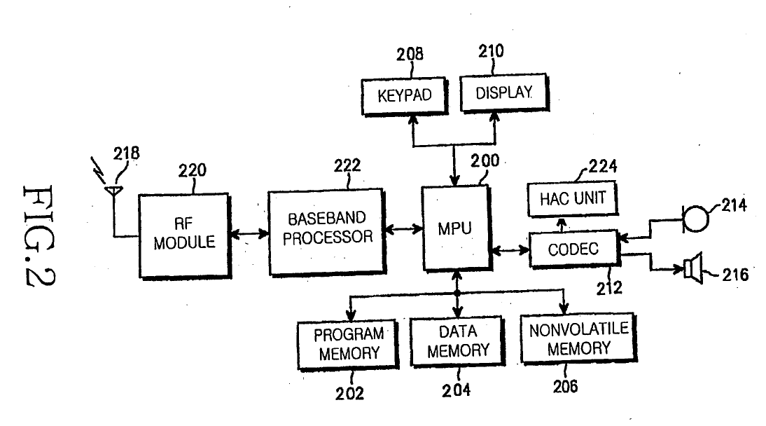

FIG. 2 is a block diagram illustrating a portable wireless terminal for the hearing impaired according to an embodiment of the present invention. The term “portable wireless terminal” is used hereinafter to denote various wireless mobile terminals such as a cellular phone, a Personal Communication Service (PCS) terminal, an International Mobile Communication-2000 (IMT2000) terminal, a 4G (OFDM: Orthogonal Frequency Division Multiplexing) terminal and other like devices. The general structure of the portable wireless terminal will now be described in detail.

Referring to FIG. 2, a microprocessor unit (MPU) 200 controls an overall operation of the portable wireless terminal. For example, the MPU 200 processes and controls voice communication and data communication. For the sake of clarity, a detailed description of typical process and control operations of the MPU 200 has been omitted.

A memory includes a program memory 202, a data memory 204 and a nonvolatile memory 206. The program memory 202 stores a program for controlling the overall operation of the portable wireless terminal. A flash memory can be used as the program memory 202. The data memory 204 temporarily stores data that is created during the operation of the portable wireless terminal. A random access memory (RAM) can be used as the data memory 204. The nonvolatile memory 206 stores system parameters and other data (e.g., phone numbers and/or SMS messages). An electrically erasable and programmable read only memory (EEPROM) can be used for the nonvolatile memory 206.

A keypad 208 includes Numeric keys of digits 0-9 and a plurality of Function keys, such as a Menu key, a Cancel (Delete) key, a Conformation key, a Talk key, an End key, an Internet connection key, Navigation keys (Left/Right/Up/Down, etc.). Pressing the keypad 208 inputs corresponding key input data which is transmitted to the MPU 200. A display 210 is used for displaying numerals and characters, moving pictures and still pictures, status information (or status indicators) of the terminal, and the like. A color liquid crystal display (LCD) can be used for the display 210.

A coder-decoder (CODEC) 212 connected to the MPU 200, a speaker 216 and a microphone 214 are connected to the CODEC 212 and form an audio input/output block that is used for a voice communication. The MPU 200 produces pulse code modulation (PCM) data and the CODEC 212 converts the PCM data into an analog audio signal. The analog audio signal is outputted through the speaker 216. Also, the CODEC 212 converts an audio signal received through the microphone 214 into PCM data and provides the PCM data to the MPU 200.

A Radio Frequency (RF) module 220 demodulates an RF signal received through an antenna 218 and provides the demodulated RF signal to a baseband processor 222. Also, the RF module 220 increases modulates a baseband signal provided from the baseband processor 222 and transmits an RF signal via the antenna 218. The baseband processor 222 processes the baseband signals that are transmitted/received between the RF module 220 and the MPU 200. For example, in the case of the data transmission, the baseband processor 222 performs a channel coding and spreading on the transmitting data. In the case of the data reception, the baseband processor 222 performs a despreading and channel decoding on the receiving data.

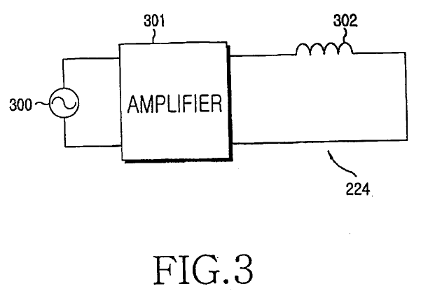

A Hearing Aid Compatibility (HAC) unit 224 of the present invention includes a telecoil (T-coil) to produce a magnetic field of sufficient strength toward the portable wireless terminals user's hearing aid (not shown). The HAC unit 224 converts an analog electric signal from the CODEC 212 into a magnetic signal. The magnetic signal is sent to an induction coil of the hearing aid of a hearing impaired person. The structure of the HAC unit 224 will now be described in more detail with reference to FIGS. 3 to 5.

FIG. 3 is a detailed block diagram illustrating the HAC unit depicted in FIG. 2. The HAC unit 224 includes an amplifier 301 and a telecoil 302 with an impedance of several hundred to several thousand ohms. The CODEC 212 generates a differential signal or a single signal. Here the CODEC 212 assumes to generate a differential signal. A signal source (300) from the CODEC 212 inputs a differential signal to HAC unit 224. The amplifier 301 receives an analog electric signal from the CODEC 212 and amplifies it to a predetermined level. The telecoil 302 converts the amplified analog electric signal into a magnetic signal. Generally, the CODEC 212 outputs a low-strength signal suitable for a small size speaker with an impedance of several 10˜90 ohms. This low-strength signal, however, is not sufficient to generate the necessary magnetic field which is required by typical hearing aids. Accordingly, the amplifier 301 is used to amplify the output signal of the CODEC 212 to produce a signal of sufficient strength. That is, the output signal of the CODEC 212 is amplified and then converted into a magnetic signal.

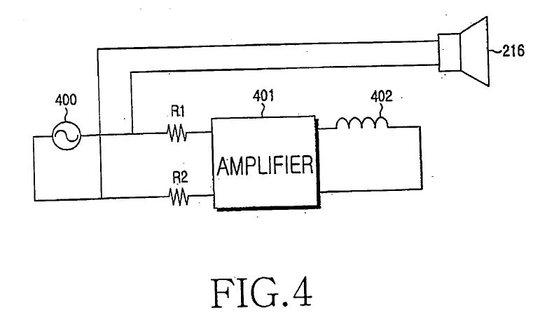

The relationship between the CODEC 212, HAC unit 224, and speaker 216 will now be described in detail. FIG. 4 is a block diagram illustrating an apparatus for producing a magnetic field in a portable wireless terminal toward a user's hearing aid according to an embodiment of the present invention. A speaker 216 typically has an impedance of between 2 and 100 ohms. The speaker 216 converts a voice-band electric signal from the CODEC 212 into an audible tone which can be easily heard by a user who is not hearing impaired.

A signal source (400) from the CODEC 212 inputs a differential signal to the HAC 224. An amplifier 401 receives a voice-band electric signal from the CODEC 212 and amplifies it to a predetermined level. Resistors R1 and R2 are connected to input ports of the amplifier 401 to determine the level of amplification. A telecoil 402 has an impedance of between several hundred and several thousand ohms and complies with the FCC's HAC Act. The telecoil 402 converts an electric signal from the CODEC 212 into a magnetic signal. The telecoil 402 is installed in a suitable location on the portable wireless terminal so that it complies with the HAC Act. The telecoil 402 can be installed at a predetermined location in the proximity of the speaker 216 to generate the magnetic field toward a user's hearing aid (not shown) or terminal user's ear.

In this manner, the speaker 216 generates the sound signal and at or about the same time, the telecoil 402 generates a corresponding magnetic signal. The sound signal of the speaker 216 is an audible signal which can be easily heard by a user who is not hearing impaired, and the magnetic signal generated by the telecoil 402 is transmitted to the hearing aid of a hearing impaired user to drive the hearing aid. In this embodiment, although both the speaker 216 and the telecoil 402 are operated at the same time, in alternative embodiments, either of the speaker 216 and the telecoil 402 can be operated alone depending on user's selection.

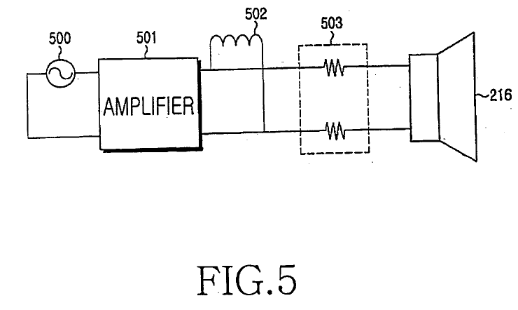

FIG. 5 is a block diagram illustrating an apparatus for producing a magnetic field in a portable wireless terminal toward a user's hearing aid according to another embodiment of the present invention. A signal source from the CODEC 212 inputs a differential signal to the HAC 224. An amplifier 501 receives a voice-band electric signal from the CODEC 212 and amplifies it to a predetermined level. A telecoil 502 has an impedance of between several hundred and several thousand ohms and complies with the HAC Act. The telecoil 502 converts an electric signal from the CODEC 212 into a magnetic signal. The telecoil 502 is installed in a suitable location on the portable wireless terminal so that it complies with the HAC Act. The telecoil 502 may be installed at a predetermined location in the proximity of a speaker 216 to produce the magnetic field which is directed to a user's hearing aid (not shown) or the user's ear. The magnetic signal of the telecoil 502 is transmitted to the hearing aid to drive the hearing aid.

An attenuator 503 attenuates the amplified electric signal from the amplifier 501 and applies it to the speaker 216 with an impedance of several to several ten's of ohms. The speaker 216 converts the attenuated electric signal into a sound signal and outputs an audible tone which can be easily heard by a non-hearing impaired user. In this embodiment, though both the speaker 216 and the telecoil 502 are operated at the same time, in alternative embodiments either of the speaker 216 and/or the telecoil 502 can be operated alone depending on a user's selection.

As described above, the telecoil 402/502 may be installed at a predetermined location in the proximity of the speaker 216 to produce the magnetic field which is directed toward the user's hearing aid and is suitable for driving the hearing aid. The installation location of the telecoil 402/502 will be described in association with an exemplary portable wireless terminal.

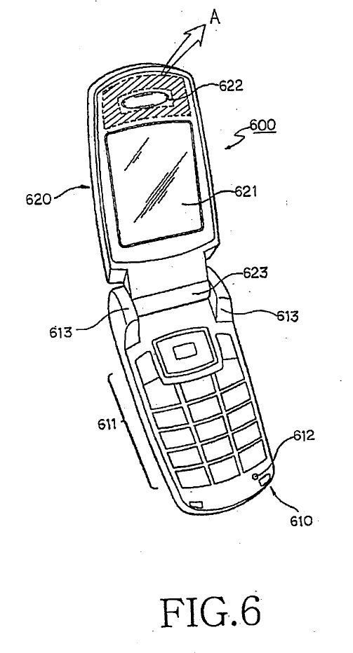

FIG. 6 is a perspective view illustration of a portable wireless terminal in the opened position according to an embodiment of the present invention. The portable wireless terminal 600 includes a main body 610, a folder 620 rotatably coupled to the main body 610, and a hinge module (not shown) enabling the rotation of the folder 620 in a predetermined range of angles (e.g., between 0 and 140° as measured from the closed position). The hinge module is installed in a center hinge arm 623 of the folder 620, and a shaft head protruding from an end of the hinge module is coupled to one of hinge arms (not shown) which are formed at both sides of the main body 610 and are used for opening and closing operations of the portable wireless terminal 600.

The main body 610 includes a keypad assembly 611 having navigation buttons as a data input device and a microphone 612 (under the keypad assembly 611) for receiving a user's voice. The folder 620 includes a Liquid Crystal Display (LCD) module 621 as an display device and a speaker 622 above the LCD 621 for outputting an audible tone. The LCD module 621 may be a wide-color LCD module. Also, the portable wireless terminal 600 can include an optional slave LCD module (not shown) at an outer surface of the folder 620 and an optional camera (not shown) above the slave LCD module for taking pictures.

The telecoil 402/502 is installed in the folder 620 in the proximity of the speaker 622. The telecoil 402/502 is preferably installed in the cross-hatched portion (A) as shown in FIG. 6.

As described above, the telecoil is installed in the portable wireless terminal to produce a magnetic field of sufficient strength in the direction of the hearing aid of a hearing impaired user, such that the hearing impaired user can make and receive calls with the portable wireless terminal. Also, the apparatus of the present invention is designed such that the amplification and attenuation levels of the amplifier and attenuator can be adjusted to comply with other Hearing Aid Compatibility (HAC) requirements of different countries. The amplifier and attenuator can be adjusted by a manufacturer to meet the countries' different HAC standards.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

While the invention has been shown and described with reference to a certain preferred embodiment thereof, it will be understood by those skilled in the art that various changes in form and details may be made therein without departing from the spirit and scope of the invention.

What is claimed is:

1. An apparatus for producing a magnetic field in a portable wireless terminal for use by a hearing impaired user, the apparatus comprising:
an amplifier for amplifying a voice-band electric signal received from a CODEC to a predetermined level; and
a coil for converting the amplified electric signal into a magnetic signal.

2. The apparatus of claim 1, wherein the coil is a telecoil (T-coil) with an impedance of several hundred to several thousand ohms and complies with Hearing Aid Compatibility (HAC) regulations.

3. The apparatus of claim 1, wherein the coil is installed in a predetermined location in proximity to a speaker of the portable wireless terminal to produce the magnetic signal in a direction of a user's hearing aid.

4. The apparatus of claim 1, further comprising a speaker with an impedance of several ohms to several tens of ohms, for converting the voice-band electric signal from the CODEC into an audible tone which can be heard by a non-hearing impaired user.

5. The apparatus of claim 1, further comprising:
an attenuator for attenuating the amplified electric signal to a predetermined level; and
a speaker with an impedance of between 2 and 100 ohms, for converting the attenuated electric signal into an audible tone which can be heard by a non-hearing impaired user.

6. An apparatus for producing a magnetic field in a portable wireless terminal for use by a hearing impaired user, the apparatus comprising:
a speaker for converting a voice-band electric signal into an audible tone;
an amplifier for amplifying the voice-band electric signal to a predetermined level; and
a telecoil for converting the amplified electric signal into a magnetic signal.

7. The apparatus of claim 6, wherein the speaker has an impedance of between 2 and 100 ohms.

8. The apparatus of claim 6, wherein the telecoil is a coil with an impedance of between several hundred and several thousand ohms and complies with Hearing Aid Compatibility (HAC) regulations.

9. The apparatus of claim 6, wherein the telecoil is installed in a predetermined location in proximity to the speaker to direct the magnetic signal toward a user's hearing aid.

10. An apparatus for producing a magnetic field in a portable wireless terminal for a hearing impaired user, the apparatus comprising:
an amplifier for amplifying a voice-band electric signal to a predetermined level;
a telecoil for converting the amplified electric signal into a magnetic signal;
an attenuator for attenuating the amplified electric signal to a predetermined level; and
a speaker for converting the attenuated electric signal into an audible tone.

11. The apparatus of claim 10, wherein the speaker has an impedance of several to several tens of ohms.

12. The apparatus of claim 10, wherein the telecoil is a coil with an impedance of between several hundred and several thousand ohms and complies with Hearing Aid Compatibility (HAC) regulations.

13. The apparatus of claim 10, wherein the telecoil is installed in a predetermined location in proximity to the speaker to direct the magnetic signal toward a user's hearing aid.
